(19) United States
(12) Patent Application Publication
(10) Pub. No.: US 2016/0253229 A1
(43) Pub. Date: Sep. 1, 2016

(54) EVENT LOG ANALYSIS

(71) Applicant: HEWLETT PACKARD ENTERPRISE DEVELOPMENT LP, Houston, TX (US)

(72) Inventors: Alon Sade, Yehud (IL); Ilya Brodin, Yehud (IL); Eran Samuni, Yehud (IL)

(21) Appl. No.: 15/033,200

(22) PCT Filed: Oct. 30, 2013
(86) PCT No.: PCT/US2013/067556

§ 371 Date: Apr. 29, 2016

(51) Int. Cl. G06F 11/07

(52) U.S. Cl. CPC G06F 11/079; G06F 11/0709; G06F 11/0751; G06F 11/0787

(57) ABSTRACT

Various methods and systems for analyzing event log elements are described that utilize numerous techniques to group and compare the large event log files logged by different computers and programs. In one example, a method includes receiving a first set of event log elements from a plurality of computers, and receiving a second set of event log elements from a target computer. The method continues by comparing the first set of event log elements and the second set of event log elements to identify a configuration difference between the target computer and the plurality of computers. The differences can be displayed to a user of the target computer.

### BACKGROUND

Various software and computer systems generate system event log files, also referred to as “logs,” that can be used to help analyze the health of a computer system. These logs, which are typically stored on networked servers, can be used in system development and for debugging and understanding the behavior of a system. While logs hold a vast amount of information describing the behavior of systems, finding relevant information within the logs can be very labor intensive. Even modest systems can log thousands of event messages per second.

### BRIEF DESCRIPTION OF THE DRAWINGS

Various features and advantages of the invention will become apparent from the following description of embodiments of the invention, given by way of example only, which is made with reference to the accompanying drawings, of which:

FIG. 1 illustrates a system for analyzing system event log elements;

FIG. 2 illustrates a log processing system operable according to embodiments of the present invention; and

FIG. 3 is a process flow diagram showing a method of analyzing system event log elements;

FIG. 4 is a schematic of a non-transitory, computer-readable medium containing code to implement event log analysis.

### DETAILED DESCRIPTION

The present disclosure provides techniques for automatically diagnosing computer and software issues by analyzing log files. Event log files can be structured or can be unprocessed, semi-structured indications that are systematically generated when software or hardware components output messages. Such event messages typically describe actions, warnings or errors experienced by a computer system.

A myriad of processes can spawn multiple messages into logs. For example, a failure of a process can cause multiple messages to appear in different logs that represent the output of various software components, thereby creating interleaved sequences of events in the respective logs. Examples of the technology disclosed herein lead to automation in leveraging the logs for tasks such as automated problem debugging, process identification, or visualization of the Information in the logs. Such automation inherently saves time and man hours and helps solve user problems to at a particular target computer may be experiencing. Automated systems can benefit greatly from identification and representation of groups of related events, as opposed to individual messages, as this reduces noise (i.e., erroneous, meaningless, missing, incomplete, or difficult-to-interpret Information), compresses the data and facilitates a more accurate representation of processes in the system.

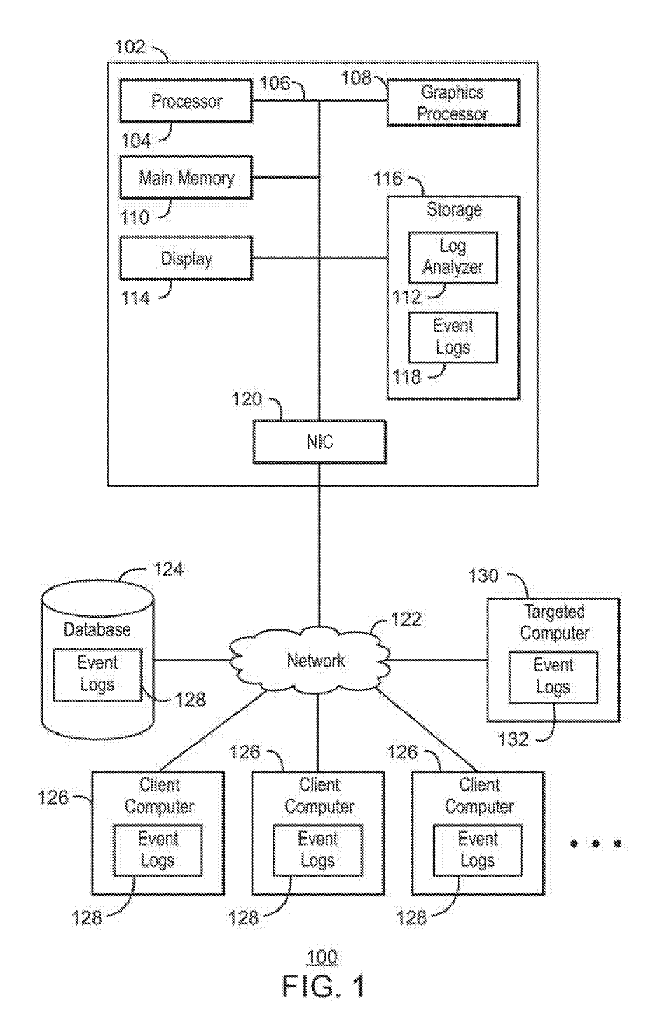

FIG. 1 illustrates a system for analyzing system event logs. The system 100 includes a network management computer system (the network manager) 102 that runs software applications or controlling, monitoring and configuring other network system components. Such network managers 102 are known and may run a network management software application, such as Hewlett Packard™ Open View™. The network manager 102 includes a processor 104 connected via a communication bus 106 to a graphics processor 108, main memory 110, the log analyzer 112, a display 114, a storage component 116 that stores event logs 118, and a network interface controller 120 that connects the network manager 102 to a network 122.

The network 122 of the system 100 can be, for example, an enterprise intranet, or any other arrangement or combination of one or more network types including the internet. Connected to the network are a database 124 and client computers 126. which may be personal computers or other processors. Including a server, a network-attached printer, and a network-attached storage device, which may be anything from a single disk drive to a storage library, for example. Any one or more of the devices and systems, e.g., client computers or servers 128 and network databases 124. which are connected to the network 122, may generate event logs 128, Typically, the devices and systems are configured to communicate the events to the network manager 102. The network manager 102 stores received events in one or more event logs 118 on a storage device, such as hard disk storage 116.

The network manager 102 includes one or more processors 504 providing an execution platform for executing software. Thus, the network manager 102 includes one or more single-core or mulls core processors of any of a number of computer processors, such as processors from Intel, AMD, and Cyrix, for example. As referred herein, a computer processor may be a general-purpose processor, such as a central processing unit (CPU) or any other multi-purpose processor or microprocessor. A computer processor also may be a special-purpose processor, such as a graphics processing unit (GPU) 108, an audio processor, a digital Signal processor, or another processor dedicated for one or more processing purposes. Commands and data from the processor 104 are communicated over a communication bus 106 or in through point-to-point links (not shown) with other components in the network manager 102.

The network manager 102 also includes a main memory 110 where software is resident during runtime, and can include additional secondary memory (not shown). Additional secondary memory can also be a computer-readable medium that may be used to store software programs, applications, or modules that implement the techniques herein, or parts thereof. The main memory 110 and optional removable storage unit (not shown), each can include, for example, a hard disk drive anchor a removable storage drive representing a floppy diskette drive, a magnetic tape drive, a compact disk drive, etc., (or a non-volatile memory where a copy of the software is stored. As an example. the main memory 110 can also include ROM (read only memory), EPROM (erasable, programmable ROM). EEPROM (electrically erasable programmable ROM, or any other electronic, optical, magnetic, or other storage or transmission device capable of providing a processor or processing unit with computer readable instructions. The network manager 102 can include a display 114 connected via a display adapter (not shown). User interfaces comprising one or more input devices, such as a keyboard, a mouse, a stylus, and the like can additionally be connected to the network manager 102. However, the input devices and the display 114 are optional. A network interface controller 120 is provided for communicating with other computer systems 126 or databases 124 via for example, the network 122.

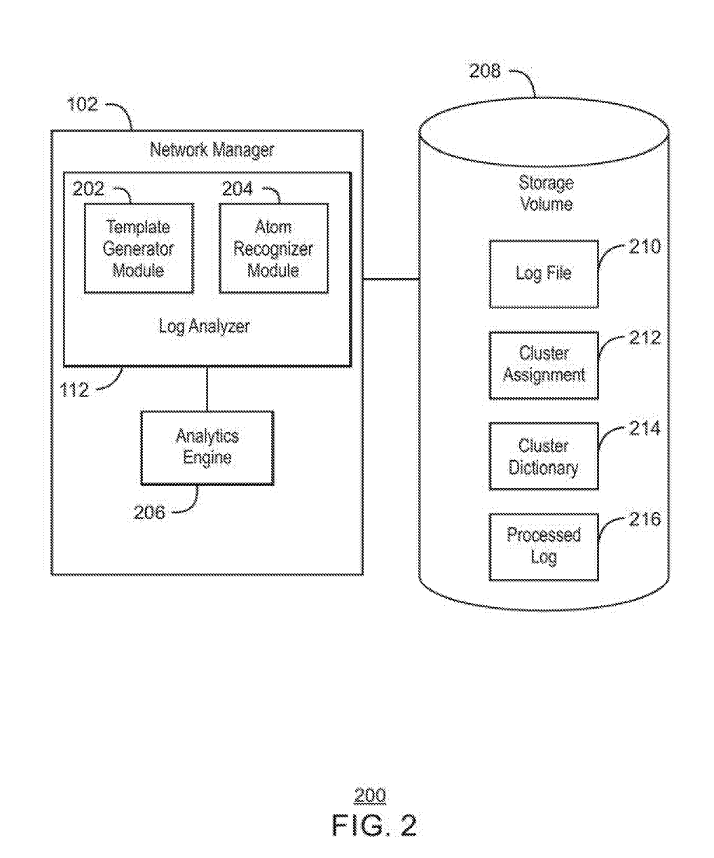

The log analyzer 112 performs the automated techniques described herein. Log analysis can, for example, be implemented by a dedicated hardware module, such as an application-specific integrated circuit (ASIC), in one or more firmware or software modules, or in a combination of the same. A firmware embodiment would typically comprise instructions stored in non-volatile storage, which are loaded into the processor 104 one or more instructions at a time, to control the network manager 102 according to examples of the current techniques. Additional software components of the network manager 102 and the interactions therein are included, and are discussed in more detail in FIG. 2.

The analysis of particular event logs can be initiated by a user that is experiencing issues with a targeted computer 130 or a network of computers 126. The event logs 132 of the riser targeted compute 130 can be complied by different means, and compared to similar event logs 128 indicated by the other computers 126 on the network 122. The differences can he displayed automatically for the user, significantly reducing time and effort that would otherwise be necessary to troubleshoot computer problems by searching for inconsistent event logs. Once differences between the target computer and the network of computers have been identified, the user can advantageously troubleshoot the target computer 130 and remedy the issues mentioned. The target computer 130 can also be targeted software. The current techniques. should be understood to he able to diagnose software issues inherently present within a targeted computer in a network of computers. Targeted client event log elements can thus be compared to event log elements from similar software flows for different clients on the network.

The diagram in FIG. 2 illustrates a log processing system operable according to embodiments of the present invention. The system 200 includes the network manager 102 of FIG. 1, which includes the log analyzer 112. The log analyzer 112 includes a template generator module 202 and an atom recognizer module 204, and can include other modules (not shown) used to compile and compare event logs. In addition to the log analyze 112, the network manager 102 also includes an analytics engine 206. Each of the analytics engine 206 and log analyzer 112 has data read and write access to storage volume 208, which can be a hard drive of a network system computer, a database, or any number of storage devices on the network 122 where event logs are filed, including the storage device of the network manager 102 itself. The event log files 210 and other data structures stored in the storage volume 208, include in this example cluster assignment data 212, a cluster dictionary 214 and a processed log 218.

According to an example of the disclosed technique, the log analyzer 112 and analytics engine 206 may be implemented as software applications that are loaded into main memory 110 and executed on the network manager 102. System monitors, which are known in the prior art but are not currently shown, can, optionally, be employed according to embodiments of the present invention. The event log files 210 and other data structures (or parts thereof) can be loaded into main memory 110 of the network manager 102 to afford faster read and write operations, and then loaded back into the disk storage volume 208 when read and write operations are completed. The manner of storage and data read/write operations is not important to the present invention, as long as the processes are sufficiently fast.

In many areas there is a desire to characterize objects according to the elements from which they comprise. Examples can be found the field of software event stream analysis, which aims to discover sequences of events that describe different states in a system that runs complex applications using, for instance, analysis of event log elements. Existing research in the area of automated log analysis focuses on discovery of temporal patterns, or correlation of event statistics within the events. Such techniques are typically based on knowledge of which event messages can occur, or require access to the source code of software that generates the event messages in order to determine which event messages can occur. In general, the research does not accommodate the complexities of real world systems, in which logs may be generated by various different components in a complex system, leading to, for example, interleaving of sequences of events, asynchronous events and high dimensionality.

The log analyzer 112 includes a template generator module 202 and an atom recognizer module 204, the operations of which are according to techniques that will now be described in detail. The template generator module 204 utilizes a set of message clusters that forms the cluster dictionary 214 (i.e., dictionary of event types), with each cluster representing, and being represented by, a message event template text. To create a cluster dictionary 214, mapping the events to a typically much smaller set of message clusters, the template generator module 202 applies the assumption that event log elements produced by the same template (albeit unknown in advance) are usually identical in many of the words, with differences only at various variable parameters. Additionally, word ordering is typically important. Therefore, it is assumed that any appropriate similarity function needs to take word ordering into account. An order-sensitive cosine similarity function, for example, can be applied to provide a measure of similarity (i.e., a ‘distance’) of two messages. Any suitable similarity function may be applied in embodiments of the present invention.

The cluster dictionary 214 described according to the present embodiment is produced using a template generator module algorithm. Each cluster in the cluster dictionary 214 includes at least an event template, comprising the text (or some other appropriate representation of the text, such as, for example, an encoded or hashed variant or a pointer to the text in a template database or the like) of a representative log event message, and a message count indicating the number of times a log event message has been assigned to the cluster. In effect, each cluster represents a prototypical feature message according to a representative message.

A message template is essentially a string of similar text where some variable or variables are constant and in common between log messages in the message template. A message within the template, a specific word or character or string, can relate to some cluster in the message template. To illustrate, a hypothetical error log may read something like, “failed to retrieve the meta data of project ‘YYYY’ the session authentication has failed.” The message template would be the string of text surrounding and related to the ‘YYYY’ indication. This text is common for the particular type of error message. The cluster is “YYYY” itself, and is unique for a particular computer. One computer on the network of computers might give the ‘YYYY’ indication, while another could give a different indication, such as ‘XXXX’ or ‘ZZZZ’, etc. These can be thought of as variables (i.e., numbers, words, or symbols) in the narrative text of the log event that have been inserted into the message templates. It is useful to be able to quickly organize and recognize these in the message through grouping the related clusters.

As indicated, the template generator module 202 works by an algorithm and begins with zero or more clusters defined in the cluster dictionary 214, and a first event is then read from the log file 210 and compared with existing clusters to see if the event matches the template in any existing cluster. The output of template generator module 202 can be thought of as a forest of cluster trees, in which the branches of the tree represent splits based on an entropy criterion, and the tree roots are based on a cosine similarity criterion. The template generator module algorithm efficiently indexes the logs, reducing space requirements and significantly speeding up a log search over standard indexing techniques.

The template generator module 202 processes the logs and creates sets of clusters, unique messages and word dictionaries. These data templates have effectively been converted from raw error logs into a standard data format that is easier to analyze. The output of the log analyzer 112 can be applied to the efficient indexing of the logs, thereby reducing space requirements and significantly speeding up searches through the logs over standard indexing. The clusters (and cluster assignments) that have been defined can serve as an index to each event. Coupled with the varying words, the clusters can produce a very fast and small index representing exactly all event logs. Another component of the log analyzer 112 can include an atom recognizer module 204. The atom recognizer module 204 functions through utilizing the clusters that have already been created, and generating sets of atoms whereby event log elements can be more efficiently organized by strongly correlated flows.

An atom can be defined as a set of elements that is common in many samples contained in a data set, and therefore is potentially meaningful in some sense. As such, a new or existing set can be sparsely represented using such atoms. An atom recognizer module 204 is used to identify atoms which can be used to sparsely represent a set of documents. The atom recognizer module 204 is executed by the network manager 102, and can take as input data representing a data set to be analyzed, such as data representing a corpus of documents, e.g., raw event logs, event message templates, or other event log elements. The corpus of documents can be provided by a storage volume 208, which comprises, for example, a hard drive disk (HDD). The data from the storage volume 208 is used in a training phase in order to determine a set of representative atoms. Process steps can occur with a computing system such as the network manager 102 as described with reference to FIG. 1. Storage volume 208 can be an integral part of the computing apparatus, or can be remote (as depicted in the exemplary system of FIG. 2).

An area where there is a desire to characterize objects according to the elements from which they comprise includes document characterization. This aims to describe and characterize documents in a corpus according to the concepts they discuss by using the words from which the documents are composed. Following characterization, each document in the corpus, or indeed new documents added thereto, can generally be represented sparsely using these concepts. The representation can be used as an aid in keyword extraction, or concept based retrieval and search for example. Document characterization works can use probabilistic latent semantic indexing for example, to produce models that capture latent concepts in documents using a corpus of training documents and different finite mixture models. In general, existing approaches for characterizing a corpus of documents use a compressed representation of the data which is learned from data through probability distributions over words and concepts.

An exemplary use of the processed leg 216 by the analytics engine 206 is to aid in diagnosis of system problems. In most computer systems, indications of problems stem from abnormal measurement values associated with computer system behavior, such as transaction response time or throughput. This behavior information is generally referred to herein as system monitor information. Such measurements are typically made and reported to human operators (i.e., system administrators) by known system and/or network monitoring applications (or ‘monitors’) such as OpenView™ software available from Hewlett Packard® Company and Microsoft NT 4.0 Performance Counters available from Microsoft®. When monitors indicate a problem, the human operators typically need to discover the root cause, quite often by sifting through huge amounts of unprocessed, semi-structured log files (e.g., raw log files 210). Monitors typically measure system behavior, such as CPU, memory and network utilization, and may present the respective system monitor information graphically.

Another exemplary use case of the processed log 216 by the analytics engine 206 is for visualization of system event logs over time, for gaining a better understanding of the overall system operation. Visualization of the log events over time produces views that enable a quick and intuitive understanding of normal system operation, such as reboots, normal periodic processes (e.g., database partition), and abnormal operation such as processes that are running amok, while not causing any detectable problem at the application level (at least to begin with). Whereas in the first use case the diagnosis of a specific problem that occurred is a supervised learning problem, this second use case can be unsupervised, leveraging visualization and additional unsupervised techniques for early detection of anomalies or undesirable behavioral patterns from the logs. Visualization uses messages from system logs following the dictionary creation by the template generator module 202.

An automated method is used for determining a set of atoms which are representative of the content of a body of content. In a first stage, atoms are generated by taking as input a corpus of documents (although it will be appreciated that fewer than a plurality of documents can be used, such as one for example). That is to say, an input data set is provided to the atom recognizer module 204 to generate a set of representative atoms. The atoms derived according to the process for the input object (e.g., event log elements) can be used to summarize it, for example, thereby providing processed log 216. The atoms can be used for document summarization where existing documents, such as the event log element inputs, and/or new documents are summarized using the atoms which have been generated as a dictionary of atoms (not shown). The addition of new atoms which better represent the content of the new material can be generated and used to implement a form of log analysis described herein.

More specifically, this stage of atom generation can be thought of as a training phase in which a user provides a document or corpus of documents as input to the system. The system parses the documents to words, and represents each document by the set of words that are present in the document. Accordingly, each document is a sparse vector (with the size of the vector being the entire dictionary), where there is a “1” in the location of words that are present in the document, and “0” everywhere else. The above-described process is then carried out on the corpus of documents which are now represented as sparse vectors, and the output is a set of atoms, wherein each atom is the size of the dictionary, with “1”s in locations of words included in the atom and “0” everywhere else.

In a representation phase, a user can provide a document as an input to the system so that it can be transformed into a sparse vector. Accordingly, the system can then find which atoms from the output best represent the document and provide these atoms as the summarization of the document.

Atoms derived according to the present embodiments can be used in order to define a keyword representative of the content of a data set. Accordingly, an atom or set thereof for a particular document can be provided as keywords for that document which can be used to speed up searching, for example, or otherwise can be used to more simply represent a document. In an exemplary embodiment, an initial data set can represent a user (customer, client, etc.) profile, and can further represent an error indication in the event log, as one example, for that user. Accordingly, a set of atoms generated for the user will therefore provide a representation of the same. It is therefore possible to use the atoms for the user in order to predict an element of interest to troubleshoot that user computer based off the processed element that is compared against the processed elements of other computers in the system.

Information received from a system monitor, indicating failures, can be used in tandem with log analyzer information, in order to diagnose system failures. Once it is known which atoms, or combination of atoms, occur concurrently with (or, indeed, precede) system failures, it would not be essential to refer to monitor information in order to diagnose recurrences of the problems.

The log analyzer 112 can include a storage engine, a comparison engine, a differentiation engine, and a display engine that can be configured to implement the techniques described herein. Each engine includes a combination of hardware and programming. For example, the engine hardware can be a non-transitory, computer-readable medium for storing the instructions, one or more processors for executing the instructions, or a combination thereof.

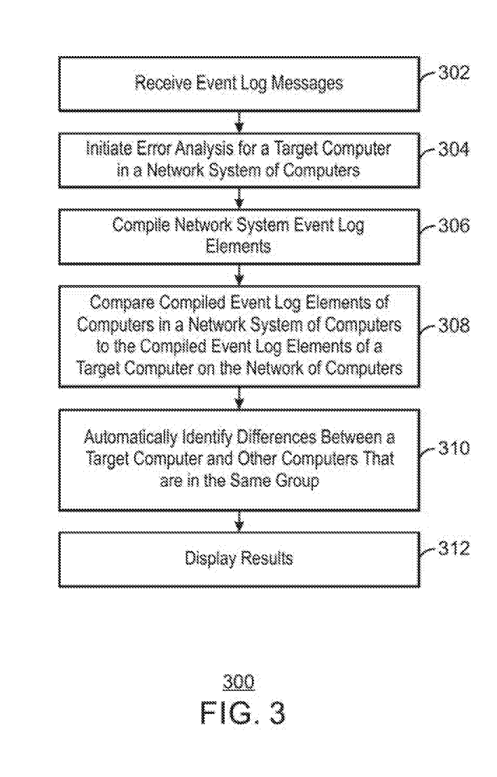

FIG. 3 is a process flow diagram showing a method of analyzing system log files. The method 300 starts at block 302 where event log messages are received at a computer, for example, a network management computer system 102. The event logs 128, 132 are received from computers of the network of computers 126, including a targeted computer 130. Those received event logs can be stored 118 and processed further in the network manager 102 storage volume 116. Error analysis can then be initiated by a user at block 304 for a target computer 130 in a network system of computers 128, where the target computer 130 can be, but is not limited to, a personal computer, a server, a digital printer, a database, etc. A user could want to initiate the error analysis and target a computer because that computer of the system of computers is malfunctioning in some manner. The computer can be targeted by the user for error analysis and comparison between the network of computers to troubleshoot and remedy issues that might be present.

At block 306, the network system event log elements are compiled. The compilation of the event log elements can be achieved in a number of ways. For example, event log elements can be compiled into so-called “clusters” of message templates. Another compilation method to better organize event log elements includes utilizing those data compiled into clusters to generate sets of atoms from the message templates. Through either example of grouping of the event logs by clusters into message templates, or by generating sets of atoms or “flows,” the event log elements can be efficiently translated and compiled into an organized, more machine readable format.

Log analysis involves generating a dictionary of event types that comprise a limited set of templates to represent the events in the logs. The message templates are then used to identity groups of related events, for example, where each group may relate to one kind of system or application software (or a respective component thereof), process or failure. The result is a conversion of system event logs from semi-structured text to a form which can be machine-read and can advantageously be used in various systems analysis, problem solving, and other computer system related tasks, as will be described in further detail.

If the log event message templates were known in advance, it would be relatively easy to map each message to its generating template. However, such templates are in practice rarely known in advance. In addition, the number of events with distinct messages in the log files has been found to be represented by between about 10-70% of the total number of events. With millions of events being logged, even automated analysis on the event log time sequence becomes difficult. Another type of behavior has been observed in logs when a system reaches a certain state, then causes different software components to output log entries that are sometimes in an ordered sequence, sometimes in an unordered sequence. Some of the event types always occur when an authentication failure occurs, whereas an additional event is found to occur in other states. Event occurrence for one computer does not necessarily mean there is a failure, but when it occurs only for the targeted computer it can help to understand the root cause of the problem. It has been found desirable, therefore, according to embodiments of the invention, to capture such processes and represent them as one event for better characterization of the system behavior. This requires automatically discovering such event sequences from the massive logs, a prerequisite for which is that log events can effectively be compared and matched. The techniques described herein generally relate, but are not limited to system log analysis, and compiling of event log elements into readily identifiable templates. Such templates can be further analyzed and structured into sets of atoms.

Regardless of the analytical method utilized to compile the event log elements, at block 308 the compiled event log elements or the network computer system as a whole will be compared to those compiled event log elements of a single target computer or server on the network. At block 310, the method automatically identifies the differences between the compiled event log elements of a target computer and those of other computers on the network. Indications will be more quickly made between event log elements that are in the same or similar grouping. The method 300 then concludes at block 312, where the resulting message template differences that were identified are finally displayed.

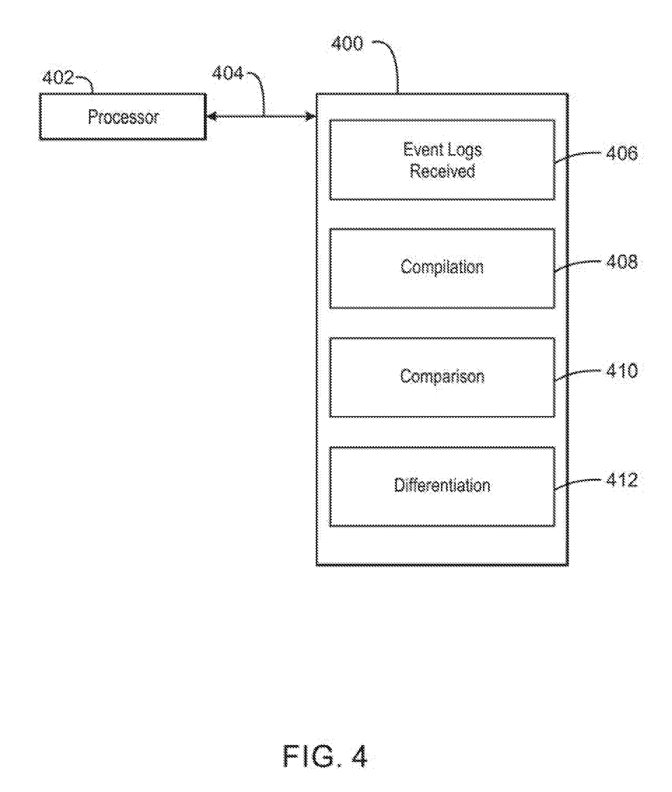

FIG. 4 is a schematic of a non-transitory, computer-readable medium containing code to implement event log analysis described herein. The tangible, computer-readable medium is referred to by the reference number 400. In the context of this disclosure, a “computer-readable medium” can be any means that can contain, store, communicate, propagate, or transport the program for use by, or in connection with, the instruction execution system. The computer readable medium 400 can be, for example but not limited to, a system or propagation medium that is based on electronic, magnetic, optical, electromagnetic, infrared, or semiconductor technology. Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). The tangible, non-transitory, computer-readable medium 400 can comprise RAM, a hard disk drive, an array of disk drives, an optical drive, an array of optical drives, a non-volatile memory, a universal serial bus (USB) drive, a digital versatile disk (DVD), or a compact disk (CD), among others. The tangible, non-transitory, computer-readable medium 400 may be accessed by a processor 402 over a computer bus 404. Furthermore, the tangible, non-transitory, computer-readable medium 400 can include code configured to perform the techniques described herein.

As shown in FIG. 4, the various components discussed herein can be stored on the non-transitory, computer-readable medium 400. A first region 406 can include an event log receiver module for receiving the event logs from a computer on the system of computers. A region 408 can include a compilation module for compiling the event log elements into more organized and more meaningful data. A region 410 can include a comparison module for comparing the compiled event log elements of a target computer, for example, to the compiled event log elements of other computers of the network of computers. A region 412 can include a differentiation module for identifying and indicating the differences between the compiled event log elements of the target computer and the other computers of the network of computers. The differentiation module can identify the existence of and the distribution among event log elements between the target computer and multiple computers on the network of computers. Although shown as contiguous blocks, the software components can be stored in any order or configuration. For example, if the tangible, non-transitory, computer-readable medium 400 is a hard drive, the software components can be stored in non-contiguous, or even overlapping sectors.

While the present techniques may be susceptible to various modifications and alternative forms, the exemplary examples discussed above have been shown only by way of example, it is to be understood that the technique is not intended to be limited to the particular examples disclosed herein. Indeed, the present techniques include all alternatives, modifications, and equivalents falling within the true spirit and scope of the appended claims.

What is claimed is:

1. A method, comprising:
receiving a first set of event log elements from a plurality of computers;
receiving a second set of event log elements from a target computer;
comparing the first set of event log elements and the second set of event log elements to identify a configuration difference between the target computer and the plurality of computers; and
displaying the difference to a user of the target computer.

2. The method of claim 1, wherein the event log elements are compiled through clustering into message templates before comparing.

3. The method of claim 2, wherein each set of event log elements are assigned to a message cluster according to a message template of similarity between the respective text of the event log element and the template text of the message cluster.

4. The method of claim 2, wherein a message cluster is periodically divided on the basis of pre-determined splitting criteria that includes greater than a minimum number of event messages being assigned to a message cluster.

5. The method of claim 2, wherein the clustered message templates are used in generating a set of machine-readable atoms grouped by flows, wherein:
an atom is a set of elements that is common in a plurality of data sets such that a new or existing set can be sparsely represented using such atoms.

6. The method of claim 5, wherein generating a set of atoms comprises minimizing a cost function using an iterative process to identify the one or more atoms.

7. The method of claim 5, wherein training data representing an initial data set including text representing at least one concept embodied by the data set is received; the training data is processed in order to generate a set of atoms, each atom comprising at least one word that represents one or more concepts of the initial data set: and wherein an initial data set represents a user, and an atom is used in order to predict an item of interest for the user.

8. A system for analyzing event log elements, comprising:
a storage engine to receive and store system event log elements as machine-readable data sets;
a comparison engine to compare event log elements from a plurality of computers to event log elements from a target computer;
a differentiation engine to identify a configuration difference between the event log elements from the target computer and the event log elements from the plurality of computers; and
a display engine to display the configuration difference that is identified.

9. The system of claim 8, wherein the comparison engine compares event log elements based on pre-determined distribution parameters that can be configured and reconfigured.

10. The system of claim 9, wherein the distribution parameters are user defined based on event log error messages received at the target computer.

11. The system of claim 8, wherein the comparison engine organizes the event leg elements into sets of message clusters and compares the message clusters.

12. The system of claim 8, wherein the comparison engine organizes the event log elements by atomic flows and compares the flows.

13. A non-transitory, computer-readable medium, comprising instruction configured to direct a processor to:
receive system event log elements as organized data sets;
compare the received event log elements of a target processor on a network of processors to other processors on the network of processors; and
automatically identity configuration differences between the event log element distribution of the target network processor and the event log element distribution of the entire network system of processors.

14. The non-transitory, computer-readable medium of claim 13, wherein the target network processor comprises a personal computer, a server, a digital printer, or any other processor connected to the network system of processors.

15. The non-transitory, computer readable medium of claim 13, wherein the target network processor requires troubleshooting, and the event log elements of interest relate to error logs that are being logged by the target network processor.
